(19) United States
(12) Patent Application Publication
(10) Pub. No.: US 2026/0217083 A1
(43) Pub. Date: Jul. 30, 2026

(54) Cooling System for a Motor Vehicle

(71) Applicant: MAHLE International GmbH, Stuttgart (DE)

(72) Inventors: Thomas Strauß, Notzingen (DE); Sascha Lindauer, Schorndorf (DE)

(21) Appl. No.: 19/444,404

(22) Filed: Jan. 9, 2026

(30) Foreign Application Priority Data
Jan. 10, 2025 (DE) 102025100802.7

(51) Int. Cl. B60H 1/00; B60K 1/00

(52) U.S. Cl. CPC B60H 1/00278; B60H 1/00392; B60H 2001/00307; B60K 2001/005

(57) ABSTRACT

A cooling system for an electric vehicle composed of a cooler circuit, battery circuit, chiller circuit, electronics circuit, and first switching valve, wherein the individual cooling circuits can be subdivided into subcircuits.

### CROSS-REFERENCE TO RELATED APPLICATIONS

This application claims priority to German Patent Application No. DE 102025100802.7, filed on Jan. 10, 2025, the entirety of which is hereby incorporated by reference herein.

The invention relates to a cooling system for a motor vehicle, a thermal management module, and a motor vehicle that has such a cooling system or thermal management module, according to the independent Numbered Paragraphs.

U.S. Pat. No. 11,807,067 B2 discloses a cooling system for a motor vehicle that contains an 8-way valve with which different cooling circuits can be connected to one another to distribute heat with the vehicle.

The object of the invention is to design a cooling system for a motor vehicle with which existing heat can be used and distributed advantageously in a motor vehicle in a variety of operating states, with as few circuit components as possible, and requiring little installation space.

To do this, a cooling system for an electric vehicle according to the features of Numbered Paragraph 1 and the dependent Numbered Paragraphs, a thermal management module that contains such a cooling system, and a motor vehicle that has such a cooling system or thermal management module, are proposed.

The cooling system for an electric vehicle obtained with the invention contains four main cooling circuits that can be connected to one another by a first switching valve with eight ports. This first switching valve can assume five different settings, thus allowing the main cooling circuits to be connected to one another in a variety of ways. These main cooling circuits can also be broken down into subcircuits.

The first switching valve can have a valve body in the form of a rotating sphere or cylinder with channels passing through it. Various connections can be obtained by rotating the valve body in relation to the ports. This could also be obtained with numerous multiport valves. The disadvantage with this is that it is significantly more complicated and expensive than a single switching valve with which all of the necessary connections can be obtained.

By placing the ports and their connections within the valve, an advantageous fluid distribution can be obtained within this first switching valve. Consequently, the main cooling circuits can be placed such that thermal losses between the coolants, which may be at different temperatures, can be reduced, thus resulting in a more efficient system.

The main cooling circuits all contain the same coolant, usually a mixture of water and glycol. Other coolants could also be used, e.g. oils or other media specifically designed for such.

The main cooling circuits are a cooler circuit, battery circuit, chiller circuit, and electronics circuit.

The cooler circuit, chiller circuit, and electronics circuit can be subdivided into subcircuits that can be switched on and off, interconnected, or operated individually.

The first setting S1 of the first valve connects the first port to the seventh, the eighth to the second, the sixth to the third, and the fourth to the fifth.

In this first setting, the return from the chiller circuit is connected to the intake for the battery circuit, and the return from the chiller is connected to the intake for the chiller. The return from the cooler circuit is connected to the intake for the electronics circuit, and the return from the electronics circuit is connected to the intake for the cooler circuit. Consequently, the battery circuit and chiller circuit are connected to one another, and the cooler circuit is connected to the electronics circuit.

A second setting S2 connects the first port to the seventh, the fourth to the third, the eighth to the fifth, and the sixth to the second.

This conducts coolant from the electronics circuit to the cooler circuit, and from there to the battery circuit, from where it then returns to the electronics circuit. The chiller circuit is not connected to any of the other circuits.

A third setting connects the first port to the fifth, the sixth to the second, the eighth to third, and the fourth to the seventh.

This connects the electronics circuit to the battery circuit. The cooler circuit and chiller circuit are also connected to one another.

A fourth setting S4 connects the first port to the second, the fourth to the fifth, the sixth to the third, and the eighth to the seventh.

In this case, the electronics circuit is connected to itself, such that coolant circulates through it, while the battery circuit and chiller circuit are connected to one another. The cooler circuit is inactive and coupled to itself.

A fifth setting S5 of the first switching valve connects the first port to the third, the fourth to the second, the sixth to the fifth, and the eighth to the seventh.

This setting and the associated placement of the intakes and outlets of the main cooling circuits results in an optimal separation of the different temperatures in the main cooling circuits, minimizing thermal losses between them. This increases the efficiency of the overall system.

The cooler circuit and battery circuit can be disconnected from the cooling system by this means, in that their intakes are connected to their outlets. The chiller circuit is connected to the electronics circuit.

A refrigerant circuit is also necessary in the cooling system. This contains at least one compressor, and indirect condenser, a chiller, and at least one, ideally at least two, adjustable expansion valves, placed appropriately in the refrigerant circuit. The refrigerant circuit can be operated in a heat pump mode, such that it can be used to generate heat. This heat pump mode uses heat from a heat source, which is then heated further in a cyclical process. This means of generating heat is more efficient, such that a great deal of heat can be generated with very little electricity. In modern electric vehicles, R290 (propane) or R774 (CO₂) is used in such a refrigerant system. Other refrigerants such as R1234yf can also be used.

There are mixing valves, normally 3-way valves, at various nodes for subdividing the main cooling circuits, which can either open one of two paths individually, or both simultaneously. Placing a mixing valve with at least three ports at these nodes is an essential aspect of the invention. By placing them appropriately within the cooling system, various advantages can be obtained such as the exploitation of particularly beneficial pressures. These settings could also be obtained with single valves in the subcircuits, but this substantially increases the number of parts, and therefore complexity and costs.

There is a coolant cooler in the cooling circuit. Outside air flows through this cooler, discharging heat from the coolant into the exterior, or absorbing heat from the exterior into the coolant, which can then be used in a heat pump process. The coolant cooler is usually in the front end of the vehicle, such that air can flow through it when the vehicle is moving. A fan can also be placed on the coolant cooler that blows air onto it, or draws air through it, if the airflow generated by forward travel is insufficient, or when the vehicle is stationary, e.g. when the electric vehicle needs to be cooled while charging. The grille on the vehicle can also have adjustable slats, which can be opened or closed according to the cooling needs. When the slats are closed, the vehicle is more aerodynamic and therefore consumes less electricity.

The cooler circuit also contains a first mixing valve in the form of a 3-way valve. This can access a bypass in which some or all of the coolant can bypass the coolant cooler.

The cooling circuit therefore forms two subcircuits, a cooler subcircuit and a cooler bypass circuit.

Consequently, heat exchange can be regulated or stopped entirely in the coolant cooler, depending on the operating state. The cooler circuit does not have its own water pump. Circulation therein is therefore obtained by connecting it through the first switching valve to other main cooling circuits or subcircuits.

The battery circuit contains a second heat-emitting component, which is usually the battery for the vehicle. Heat is generated in this circuit, e.g. by charging or discharging the battery, or the battery may need to be heated when it is cold outside to reach the ideal operating point. There are therefore two fundamentally different operating situations in the battery circuit, cooling and heating, that must be achieved by the same main cooling circuit in the cooling system. The battery circuit does not have its own water pump. Consequently, circulation therein is obtained by connecting it to another main cooling circuit or subcircuit.

The chiller circuit is subdivided into three subcircuits. The three subcircuits contain two water pumps and two check valves.

The first chiller subcircuit is formed by a second mixing valve and a first check valve. The second mixing valve is a 3-way valve, that either opens one of two channels separately, or both simultaneously. The first chiller subcircuit also contains a first water pump, which is connected at its intake and outlet to the third and fourth ports on the first switching valve. Consequently, the necessary volumetric flows for the cooler circuit and battery circuit, as well as the coolant temperature for the battery circuit, can be regulated, or the battery circuit can be isolated from the others.

The chiller circuit also contains a second and third subcircuit. The second chiller subcircuit contains a chiller, i.e. a refrigerant-coolant heat exchanger, with which heat can be exchanged between the coolant and a refrigerant circuit.

The third chiller circuit contains a second water pump, a second check valve, and a first cab heat exchanger. The second and third chiller subcircuits are connected to one another at first and second nodes.

Air entering the vehicle cab flows through the first cab heat exchanger, which cools this air with the cold coolant. This cooling also condensates any water contained in the air, thus dehumidifying the air entering the vehicle cab, e.g. when this air is recirculated in the cab.

The second chiller circuit water pump conveys coolant exiting the chiller to the first cab heat exchanger, and returning to the chiller through the first node via the second check valve.

Consequently, cold coolant can be supplied to the first cab heat exchanger to cool the air supplied to the cab, and/or the cab heat exchanger can transfer heat from the cab, or the air entering the cab from outside, to the coolant, which is then supplied to the chiller in the heat pump mode.

The second chiller subcircuit has no additional components and is connected to the third chiller subcircuit and first chiller subcircuit by the second node. Consequently, the chiller can provide cold coolant to, or receive heat from, the battery circuit, electronics circuit, or cooler circuit.

The electronics circuit is divided in parallel between a first heat-emitting component, e.g. power electronics, motors, or other electronic components that emit heat, numerous of which can be interconnected, and an indirect condenser, and contains a first electronics circuit water pump. Consequently, a first electronics circuit segment is formed that contains the first heat-emitting components, and a second segment is formed that contains the indirect condenser. An indirect condenser is a condenser in the refrigerant circuit that is cooled by coolant. Both refrigerant and coolant flow through the indirect condenser, thus exchanging heat between them.

Consequently, the first electronics circuit segment and second electronics circuit segment can be supplied with coolant from the coolant cooler in parallel. The coolant flow is therefore divided between the two subcircuits, but at the same temperature and pressure. The coolant in the first subcircuit flows through the first heat-emitting component and transports heat back to the first switching valve.

In this case, the outlet for the electronics circuit is connected to the first port on the first switching valve, and the intake is connected to the second port. There is a first electronics circuit node downstream of the second port, which divides the electronics circuit into the first segment and second segment. A first electronics circuit water pump is downstream of the first node in the first segment, which is upstream of the first heat-emitting components. A third mixing valve with three ports is downstream of the first heat-emitting component, which is connected to the first port.

The third mixing valve can be a 3-way valve, which opens one of two paths individually, or both simultaneously.

There is a second node in the second electronics circuit segment, which is upstream of a second water pump. The indirect condenser is downstream of the second water pump. There is a third node downstream of the indirect condenser, which is connected to the third mixing valve. Consequently, a third electronics circuit segment is formed between the third node and the second, which contains a second cab heat exchanger.

The second cab heat exchanger is a heating element through which the air entering the cab flows, thus heating the air supplied to the cab.

An optional coolant heater can be placed between the indirect condenser and the third electronics circuit node, which can supply additional heat to the second electronics circuit segment.

The additional third electronics circuit segment results in a very small cooling circuit with very little thermal mass, which can be used in a variety of ways to regulate the temperature of the coolant by means of the third mixing valve. This is particularly advantageous because it results in very little loss to the exterior resulting from heating large masses, which then could not be used for heating the vehicle cab. This also makes it possible to heat the cab quickly with the second cab heat exchanger. It is necessary to operate it in a mixed mode to regulate the temperature of the coolant, if the temperature of the coolant exiting the indirect condenser is too high for the cab heat exchanger.

The first and second electronics circuit water pumps are therefore parallel to one another in the first and second electronics circuit segments, and have nearly the same pressure levels at the intake end as a result of the connection between the first and second nodes in the electronics circuit. Consequently, the coolant flow can be easily divided between the two water pumps, because the pumps can be precisely and easily controlled or regulated in parallel when their intake pressures are the same. With the appropriate setting of the third mixing valve, the flow of coolant through the first and second segments of the electronics circuit can be set particularly beneficially. Consequently, the first segment can be efficiently separated from the second. If the third mixing valve were placed downstream of the indirect condenser at the third node in the electronics circuit, the part of the circuit between the third node and third mixing valve would still be part of the thermal mass of the first electronics circuit segment, which would not be beneficial.

If excess heat from the second electronics circuit segment is to be provided to the first segment, the third mixing valve can be set such that this heat is transferred thereto, while still keeping enough heat in the second and third sections for heating the cab. Consequently, the thermal mass, specifically the heat-emitting components, can be used to absorb heat, before this heat needs to be discharged to the exterior through the cooler circuit. Consequently, slats on the coolant cooler can first be opened later, for example, such that the aerodynamics of the vehicle are not compromised, thus conserving energy and making the vehicle more efficient.

The simple structure of the system with first and second electronics circuit water pumps and the 3-way valve forming the third mixing valve results in an advantageous means for extensively regulating the temperature of the coolant entering the second cab heat exchanger, e.g. to ensure that the coolant temperature at the second cab heat exchanger is higher, as may be the case when dehumidifying the air in the cab when it is warm outside, e.g. above 15° C.

Instead of the classic design for a refrigerant circuit, this refrigerant circuit could also have a particularly advantageous design. By way of example, vapor injection and hot gas bypass configurations result in a particularly effective means of generating heat that can be supplied to the indirect condenser, which can then be exploited for heating the cab.

Vapor injection can be used in the refrigerant circuit to significantly improve the efficiency and capacity of refrigerant circuits. This involves vaporizing a portion of the liquid refrigerant flowing through the indirect condenser in an evaporator, which is then returned to the compressor. The rest of the refrigerant is cooled further and sent to the chiller.

A substantial advantage with vapor injection is the increased cooling capacity which allows the refrigerant circuit to more efficiently cool warm air from the exterior. Another advantage is that the compressor is less likely to overheat, increasing its service life and reducing maintenance costs.

This technology also improves the performance when it is cold outside, because the evaporative enthalpy is optimized, thus maintaining the efficiency of the refrigerant circuit in adverse conditions. Operation when subject to partial loads is also optimized by vapor injection, resulting in an overall more efficient use of electricity. Because the refrigerant circuit is used to generate heat for the vehicle cab, these measures can be used to generate more heat, potentially eliminating the need for additional heaters in the refrigerant circuit.

The refrigerant circuit contains additional valves, refrigerant lines and an evaporator for generating steam where needed, resulting in an appropriate regulation and structure of the refrigerant circuit.

A hot gas bypass is another means of regulating the refrigerant circuit that optimizes operation of the compressor in certain operating conditions. In this case, part of the hot refrigerant, coming from the compressor, is sent directly to the suction circuit through a bypass, prior to entering the compressor, instead of flowing through the indirect condenser downstream of the compressor. The pressure in the refrigerant circuit can be regulated by the hot gas bypass, which is useful with fluctuating loads. This increases the flow in the compressor, thus effectively increasing the electricity provided to the refrigerant, such that more heat is discharged to the coolant circuit at the indirect condenser. Because this is also intended for heating the cab, there is no need for additional heaters in the coolant circuit. This refrigerant circuit contains at least one additional valve and refrigerant lines, resulting in an appropriate regulation and structure of the refrigerant circuit.

Both vapor injection and a hot gas bypass can conceivably be integrated in a refrigerant circuit. In this case, either the vapor injection or the hot gas bypass can be operated separately, or both can be operated simultaneously, if this appears to increase the efficiency. It would also be conceivable to incorporate just one of these in the refrigerant circuit.

The heat exchangers in the cooling circuits and refrigerant circuit can be of different types. These heat exchangers can be made of single tubes with fins between them for transferring heat to the air flowing over the fins, or absorbing heat from the air. Stacked heat exchangers composed of individual plates that are stacked to form channels for at least two fluids can also be used, in particular in the indirect condenser and the chiller. These are existing structures that can be designed and used for various applications with the appropriate refrigerants and coolants.

In a particularly advantageous version of the invention, the first switching valve, refrigerant circuit, first chiller circuit water pump, second chiller circuit water pump, chiller, indirect condenser, first mixing valve, second mixing valve, and third mixing valve form a thermal management module as a structural unit. Combining these components in a thermal management module has advantages regarding installation space. The need for long connecting lines between the components is eliminated by placing them close together. The thermal management module can be placed where it is needed in the motor vehicle, and then only requires connections to the heat-emitting components that require cooling, or heat exchangers. This thermal management module is also referred to as an indirect system, because the size of refrigerant circuit is limited to the installation space for the thermal management module, and other components connected to the system are only cooled and heated by coolant. Consequently, there is no longer any need to convey the refrigerant to an evaporator in the cab for cooling purposes. This also results in a fairly small refrigerant circuit, requiring less refrigerant. The use of R290, i.e. propane, for the refrigerant is particularly advantageous, because highly flammable gases such as propane should be kept out of the cab. This keeps the potential fire source out of the cab in a collision, giving the passengers time to escape. The smaller amount of propane also reduces the size of the fire.

The larger number of possibilities for the placement of the thermal management module in the vehicle also has advantages, because electric vehicles do not have internal combustion engines in the front and thus have more available installation space than conventional vehicles, in which the other components must be placed in the remaining space surrounding the engine.

It is impossible to describe all of the possible structural designs for the cooling circuit and its components, as well as the settings and designs of a thermal management module here.

There can be a control unit in the vehicle or thermal management module. This control unit can receive signals from temperature sensors and the individual components in the cooling system such as the first switching valve, mixing valves, water pumps, as well as the components in the refrigerant circuit, control how they function, and thus control and regulate the cooling system obtained with the invention to obtain the various operating points of the invention. Other requirements for the vehicle, or preferences of the driver can also be taken into account. These may include specific driving states, an ongoing charging process, or other current temperature signals from the cab or the exterior, as well target temperatures for the cab.

Ideally, there is a temperature sensor at the chiller outlet. A second temperature sensor can be placed between the indirect condenser and the third electronics circuit node. A third can be placed between the first electronics circuit water pump and the first heat-emitting component. A fourth can be placed between the second port on the first switching valve and the first electronics circuit node. A fifth can be placed between the bypass segment in the chiller circuit and the fourth port on the first switching valve. It should be noted that these individual temperature sensors can also be placed elsewhere, for which reason it is impossible to list all of the possible places where they could be located.

Such a cooling system can be operated in a variety of advantageous ways, such that numerous typical operating modes for a motor vehicle can be obtained. In doing so, the cooling system and its components, specifically the switching valves and pumps, are set as needed, or switched on or off. The temperature sensors, control unit, and connecting lines are used to obtain the correct settings. This cooling system also reacts to the demands of the vehicle, current driving situations, and preferences of the driver. The appropriate operating mode is selected on the basis thereof, and the cooling system is regulated accordingly.

Other advantageous embodiments of the invention are described below in reference to the drawings. Therein:

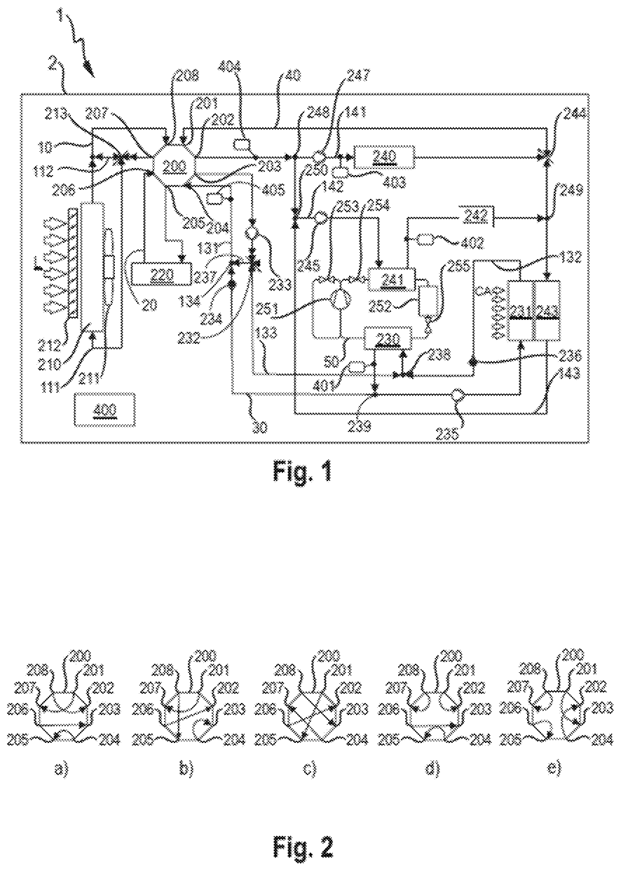

FIG. 1 shows a schematic illustration of the cooling circuit obtained with the invention;

FIG. 2 shows a first switching valve with five different settings;

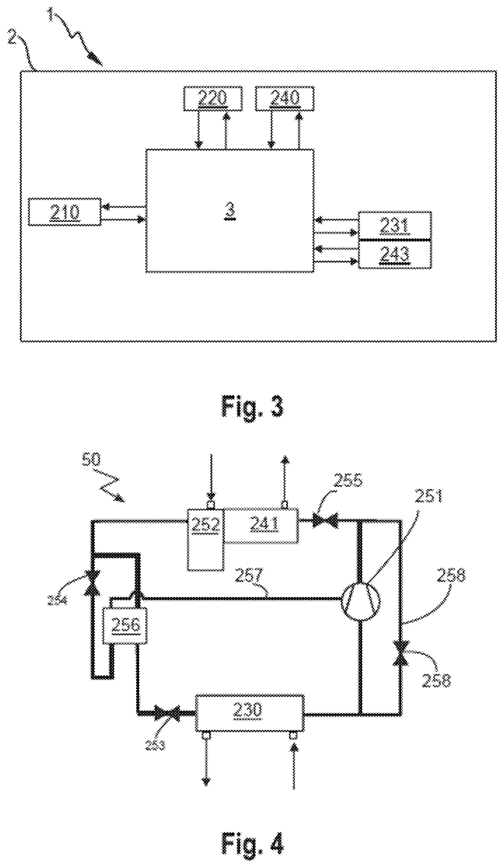

FIG. 3 shows a schematic illustration of a thermal management module; and

FIG. 4 shows a schematic illustration of a refrigerant circuit in a cooling system that has a hot gas cycle and vapor injection configuration;

### Preferred Embodiments of the Invention

FIG. 1 shows the schematic structure of a cooling system 1 obtained with the invention in a motor vehicle 2. The cooling system 1 is composed of four main cooling circuits 10, 20, 30, 40, each of which can be subdivided into subcircuits. These main cooling circuits 10, 20, 30, 40 are the cooler circuit 10, battery circuit 20, chiller circuit 30, and electronics circuit 40. A central first switching valve 200 has eight ports 201, 202, 203, 204, 205, 206, 207, 208, and can connect the main cooling circuits 10, 20, 30, 40 to one another. This means that the first switching valve 200 can be set to five different settings, connecting the different main cooling circuits 10, 20, 30, 40 to one another. The first switching valve 200 is actuated electrically to obtain the different settings. The first switching valve 200 can be a sphere or cylinder that rotates, with channels formed therein. By rotating the valve body in relation to the ports, different connections can be obtained.

The intake for the cooler circuit 10 is connected to the seventh port 207 on the first switching valve 200. The outlet is connected to the eighth port 208. The cooler circuit 10 contains a first mixing valve 213 in the form of a 3-way valve with which the cooler circuit can be subdivided into a cooler subcircuit 111 and a cooler bypass circuit 112. The first mixing valve 213 can either open just one of the two paths, or both, allowing coolant to flow through the cooler subcircuit 111 and the bypass circuit 112 at the same time. This means that the cooler circuit 10 can be operated in different modes to obtain all of the necessary operating states. There is a coolant cooler 210 in the subcircuit 111 through which air from the exterior can flow. Consequently, the coolant cooler 210 can discharge heat to, or absorb heat from the outside air. There is normally a fan 211, and there may also be slats 212, in front of the cooler that contribute to or control heat transfer, with which the necessary amount of air is conveyed to the coolant cooler 210. The fan 211 can thus draw air from the exterior and convey it through the coolant cooler 210 when the vehicle is stationary, i.e. while charging, in order to discharge heat generated by the charging process. When moving, the wind passing through may be sufficient, in which case the slats 212 can be opened or closed to regulate the airflow. This can also take place when the vehicle is stationary, if more ventilation is needed.

The intake for the battery circuit 20 is connected to the fifth port 205 on the first switching valve 200, and the outlet is connected to the sixth port 206. The second heat-emitting component 220 is also in the battery circuit 20, which is normally a battery for the electric vehicle 2.

The outlet for the chiller circuit 30 is connected to the fourth port 204 on the first switching valve 200, and the intake is connected to the third port 203. A first chiller circuit water pump 233 is downstream of the third port 203, and a second mixing valve 232, which has three ports, is further downstream. The second mixing valve 232 is a 3-way valve, which can either open just one of the two paths, or both paths simultaneously. The first chiller circuit water pump 233 circulates coolant through the chiller circuit 30. Depending on the setting of the first switching valve 200, the chiller circuit water pump can also be used to circulate coolant through one of the other main cooling circuits 10, 20, 30, 40. Consequently, the battery circuit 20 does not need its own water pump, requiring that the coolant be circulated by the first chiller circuit water pump 233, in which case the chiller circuit 20 must be connected to the battery circuit 20 by the first switching valve 200.

The second mixing valve 232, which is downstream of the first chiller circuit water pump 233, connects the outlet on the chiller circuit 30 by means of a bypass segment 237 via a third chiller node 134 upstream of the fourth port 204. There is a first check valve 234 upstream of the bypass segment 237. This forms a first chiller subcircuit 131. The chiller subcircuit 131 can be used to circulate coolant through the battery circuit 20 when the second mixing valve 232 is set accordingly, and the battery circuit 20 is connected to the chiller circuit 30 by the first switching valve 200. The first check valve 234 prevents return flow of the coolant upstream of the chiller circuit 30.

A second chiller subcircuit 133 is formed downstream of the second mixing valve 232 and upstream of the first check valve 234. A first chiller node 238 in the second chiller subcircuit 133 is downstream of the second mixing valve 232, which is connected to an intake for the chiller 230 and a return for the third chiller subcircuit 132. The third chiller subcircuit 132 contains a second chiller circuit water pump 235 and the first cab heat exchanger 231. The first cab heat exchanger 231 is a heat sink through which cold coolant flows for air conditioning the cab. Air flows through the first cab heat exchanger 231, which is either drawn from the cab or outside, or both, which is then cooled in the heat exchanger, thus cooling the cab. There is a second check valve 236 between the first cab heat exchanger 231 and first chiller node 238, which prevents return flow of the coolant toward the second chiller circuit water pump 235.

The outlet on the chiller 230 is connected to the second chiller node 239, which is connected to a return for the second chiller subcircuit 133 and an intake for the third chiller subcircuit 132.

The outlet for the electronics circuit 40 is connected to the first port 201 on the first switching valve 200 and the intake is connected to the second port 202.

There is a first electronics circuit node 248 downstream of the second port 202, which subdivides the electronics circuit 40 into a first segment 141 and second segment 142.

There is a first electronics circuit water pump 247 downstream of the first electronics circuit node 248 in the first electronics circuit segment 141, which is responsible for circulating the coolant through the first segment 141. There is a first heat-emitting component 240 downstream of the first electronics circuit water pump 247, and there is a third mixing valve 244 with three ports further downstream, which is connected to the first port 201. This first heat-emitting component 240 can be the motor or power electronics for the vehicle 2, which must be cooled. This can also comprise numerous components connected in series, which normally emit heat when in use. The third mixing valve 244 can either open just one of the two paths individually, or both simultaneously by connecting all three ports.

There is a second electronics circuit node 250 in the second segment 142. A second electronics circuit water pump 245 is downstream of the second node 250, which is responsible for circulating coolant through the second and third electronics circuit segments 142, 143. The second electronics circuit water pump 245 is connected to an indirect condenser 241 downstream of a third electronics circuit node 249, which is connected to the third mixing valve 244 and marks the start of the third electronics circuit segment 143, which is formed between the third node 249 and the second node 250.

The indirect condenser 241 is in a refrigerant circuit 50 with the chiller 230. An indirect condenser 241 is cooled by coolant, which normally discharges heat from the refrigerant circuit 50 to the coolant flowing through it.

The third electronics circuit segment 143 contains a second cab heat exchanger 243. Air entering the cab flows through the second cab heat exchanger 243, as is also the case with the first cab heat exchanger 231.

The air normally flows through the first cab heat exchanger 231 first, thus cooling it, after which it flows through the second cab heat exchanger 243, where it can heated to the desired temperature. In the winter, when the air normally only needs to be heated, the second cab heat exchanger 243 is used to heat the cab. If the air also needs to be dehumidified, or cooled when it is hot outside, the air is first cooled in the first cab heat exchanger 231.

The second electronics circuit water pump 245 circulates the coolant through the third electronics circuit segment 143. The third electronics circuit segment is reconnected at the second node 250.

To contribute to the heating of the coolant circulating through the electronics circuit 40, and to quickly heat the cab when it is cold outside using the second cab heat exchanger 243, there can be a coolant heater 242 downstream of the indirect condenser 241 and upstream of the second cab heat exchanger 243. This heater 242 could also be placed elsewhere in the third electronics circuit segment 143, even though placing it upstream of the second cab heat exchanger 243 and downstream of the indirect condenser 241 could be regarded as particularly advantageous. The heater 242 could also be subdivided into two self-sufficient components, in order to convey heat to specific points as efficiently as possible, with minimal losses, e.g. to the second cab heat exchanger 243 and the second heat-emitting component 220. There can be a control unit 400 for regulating and controlling the cooling system 1, which receives signals from temperature sensors 401-405 and sends control signals to the first switching valve 200, mixing valves 206, 232, 244, and water pumps 233, 247, 235, 245, as well as the components in the refrigerant circuit 50. Other sensor signals regarding the outside temperature, and requirements or the state of the vehicle can also be used as the basis for controlling the system.

In a particularly preferred embodiment, a first temperature sensor 401 is at the outlet for the chiller 230. A second temperature sensor 402 is between the indirect condenser 241 and the third electronics circuit node 249. A third temperature sensor 403 is upstream of the first heat-emitting component 240 and downstream of the first electronics circuit water pump 247. A forth temperature sensor 404 is downstream of the second port 208 on the first switching valve 200 and upstream of the first electronics circuit node 148. A fifth temperature sensor 405 is between the third chiller node 134 and the fourth port 204 on the first switching valve 200. It should be noted that the individual temperature sensors 401-405 can also be placed elsewhere, for which reason it is impossible to list all of the possible places where they could be located.

In the embodiment shown in FIG. 1, the chiller 230 and indirect condenser 241 are in a refrigerant circuit 50. This can be composed of a compressor 251, numerous expansion valves 253, 254, 255, and a reservoir 252. The refrigerant circuit is operated with a typical refrigerant, e.g. R290, R1234yf, or R744, and allows heat to be exchanged at the chiller 230 and indirect condenser 241, depending on the operating mode.

FIG. 2 shows the first switching valve 200 in five different settings a), b), c), d) and e). The first setting S1 a) connects the first port 201 to the seventh port 207, the eighth port 208 to the second port 202, the sixth port 206 to the third port 203, and the fourth port 204 to the fifth port 205.

In this first setting, the return for the chiller circuit 30 is connected to the intake for the battery circuit 20, and the return for the battery circuit 20 is connected to the intake for the chiller circuit 30. The return for the cooler circuit 10 is connected to the intake for the electronics circuit 40, and return for the electronics circuit 40 is connected to the intake for the cooler circuit 10. Consequently, the battery circuit 20 and chiller circuit 30 are connected to one another, and the cooler circuit 10 is connected to the electronics circuit 40. The coolant is therefore conducted from the electronics circuit 40 to the cooler circuit 10, where it can be cooled by the coolant cooler 210. The first electronics circuit water pump 247 is used to convey the coolant, because the cooler circuit 10 does not have its own water pump. The coolant in the battery circuit 20 is circulated by the first chiller circuit water pump 233, and conducted to the chiller circuit 30. Depending on the settings of the first and second mixing valves 213, 232, coolant is either further distributed or returned to the various subcircuits 111, 112, 131, 133 in the cooler circuit 10 or chiller circuit 30.

The second setting S2 b) connects the first port 201 to the seventh port 207, the fourth port 204 to the third port 203, the eighth port 208 to the fifth port 205, and the sixth port 206 to the second port 202.

Consequently, coolant is conducted from the electronics circuit 40 to the cooler circuit 10, and from there to the battery circuit 20, from where it is returned to the intake for the electronics circuit 40. Most of the circulation is provided by the first electronics circuit water pump 247, and the third electronics circuit segment 143 or second electronics circuit segment 142 can also be incorporated therein, depending on the setting of the third mixing valve 244, in which case the second electronics circuit water pump 245 may also contribute thereto.

The third setting S3 c) connects the first port 201 to the fifth port 205, the sixth port 206 to the second port 202, the eighth port 208 to the third port 203, and the fourth port 204 to the seventh port 207. This connects the electronics circuit 40 to the battery circuit 20. The cooler circuit 10 and chiller circuit 30 are also connected to one another.

The fourth setting S4 d) connects the first port 201 to the second port 202, the fourth port 204 to the fifth port 205, the sixth port 206 to the third port 203, and the eighth port 208 to the seventh port 207.

In this setting, the electronics circuit 40 is connected to itself, such that it circulates the coolant in itself, while the battery circuit 20 and chiller circuit 30 are connected to one another.

The fifth setting S5 e) connects the first port 201 to the third port 203, the fourth port 204 to the second port 202, the sixth port 206 to the fifth port 205, and the eighth port 208 to the seventh port 207.

This disconnects the cooler circuit 10 and battery circuit 20 from the cooling system 1, in that the intakes and outlets of the cooler circuit 10 and battery circuit 20 are connected to each other. The chiller circuit 30 and electronics circuit 40 are connected to one another.

FIG. 3 shows a schematic illustration of the structure of a thermal management module 3 in a motor vehicle 2, forming a cooling system 1. All of the switching and conveying elements for the cooling circuit, as well as the complete refrigerant circuit 50 are integrated in the thermal management module 3, such that only the first and second heat-emitting components 220, 240, first and second cab heat exchangers 231, 242, and the coolant cooler need to be connected to the thermal management module 3 by connecting lines. This results in a compact cooling system 1 that can be placed in a variety of locations in the motor vehicle 2.

FIG. 4 shows a schematic illustration of a refrigerant circuit 50 for a cooling system 1 that has a hot gas cycle or vapor injection configuration.

The refrigerant circuit 50 is driven by a compressor 251, wherein heat can be discharged to the coolant in the indirect condenser 241, and heat can be absorbed from the coolant at the chiller 230. The refrigerant is stored in a reservoir 252. In this embodiment, the reservoir is on the indirect condenser 241. The reservoir 252 can also be placed elsewhere in the refrigerant circuit 50. Refrigerant exiting the indirect condenser 241, or the reservoir 252, arrives at a first refrigerant node 260, where the refrigerant line is divided into two strands. A first strand is regulated by a second expansion valve 254 and conducted to an evaporator 256, and from there to the compressor by a refrigerant injection line 257. Some of the refrigerant can be conducted through the evaporator 256 by the adjustable expansion valve 254 to the compressor 251, and then returned to the refrigerant circuit. Refrigerant that is not conducted to the compressor 251, but instead arrives at the chiller 230, is conducted in the second strand through a separate fluid path in the evaporator 256 and then arrives at the chiller 230 via the first expansion valve. Downstream of the chiller, the refrigerant arrives at a second refrigerant node 261, where it is subdivided into two strands, one of which leads to the compressor 251, where the refrigerant is pressurized, while the second strand bypasses the compressor via a fourth adjustable expansion valve 259, where it rejoins the third refrigerant node 262 coming from the compressor 251. There is a third adjustable expansion valve 255 downstream of the third refrigerant node and upstream of the indirect condenser 241. The refrigerant circuit 50 can be operated in a vapor injection mode and/or hot gas cycle operating mode, depending on the settings of the expansion valves 253, 254, 255, 259. The refrigerant circuit could also be operated without the vapor injection mode and/or hot gas cycle.

The specification can be readily understood with reference to the following Numbered Paragraphs:
Numbered Paragraph 1. A cooling system (1) for an electric vehicle (2) composed of a cooler circuit (10), battery circuit (20), chiller circuit (30), and electronics circuit (40), wherein there is a first switching valve (200) that has a first port (201), second port (202), third port (203), fourth port (204), fifth port (205), sixth port (206), seventh port (207), and eighth port (208), wherein the first switching valve (200) can connect the cooler circuit (10), battery circuit (20), chiller circuit (30), and electronics circuit (40) to one another, wherein an intake for the cooler circuit (10) is connected to the seventh port (207) and an outlet for the cooler circuit (10) is connected to the eighth port (208), and the cooler circuit (10) has a first mixing valve (213) with three ports that can subdivide the cooler circuit (10) into a cooler subcircuit (111) and a cooler bypass circuit (112), wherein the cooler subcircuit (111) contains a coolant cooler (210), wherein an intake for the battery circuit (20) is connected to the fifth port (205) and an outlet for the battery circuit (20) is connected to the sixth port (206), wherein a second heat-emitting component (220) is in the battery circuit (20), wherein an outlet for the chiller circuit (30) is connected to the fourth port (204) and an intake for the chiller circuit (30) is connected to the third port (203), wherein a first chiller circuit water pump (233) is downstream of the third port (203) and a second mixing valve (232) with three ports is downstream of the first chiller circuit water pump (233), wherein a bypass segment (237) connects the second mixing valve (232) to a third chiller node (134), wherein the third chiller node (134) has a connection to the fourth port (204), wherein a first chiller subcircuit (131) is formed, wherein the third chiller node (134) has another port connected to a first check valve (234), wherein a second chiller subcircuit (133) is formed downstream of the second mixing valve (232), wherein there is a first chiller node (238) downstream of the second mixing valve (232) in the second chiller subcircuit (133), which is connected to the intake on a chiller (230) and a return for a third chiller subcircuit (132), wherein the outlet on the chiller (230) is connected to a second chiller node (239), which is connected to an intake for the third chiller subcircuit (132) and the first check valve (234), wherein there is a second chiller circuit water pump (235) downstream of the second chiller node (23) in the third chiller subcircuit (132), and a first cab heat exchanger (231) is further downstream, and a second check valve (235) is downstream thereof, wherein the second check valve (236) is connected to the first chiller node (238), wherein an outlet for the electronics circuit (40) is connected to the first port (201) and an intake for the electronics circuit (40) is connected to the second port (202), wherein a first electronics node (248) is downstream of the second port (202), which subdivides the electronics circuit (40) into a first electronics circuit segment (141) and second electronics circuit segment (142), wherein there is a first electronics circuit water pump downstream of the first electronics circuit node (248) in the first electronics circuit segment (141), wherein a first heat-emitting component (240) is downstream of the first electronics circuit water pump (247), wherein a third mixing valve (244) with three ports is downstream of the first heat-emitting component (240), which is connected to the first port (201), wherein there is a second electronics circuit node (250) in the second electronics circuit segment (142), wherein a second electronics circuit water pump (245) is downstream of the second electronics circuit node (250), wherein an indirect condenser (241) is downstream of the second electronics circuit water pump (245), wherein a third electronics circuit node (249) is downstream of the indirect condenser (241), which is connected to the third mixing valve (244), wherein a third electronics circuit segment (143) is formed between the third electronics circuit node (249) and the second electronics circuit node (250), wherein the third electronics circuit segment (143) contains a second cab heat exchanger (243).
Numbered Paragraph 2. The cooling system (1) according to Numbered Paragraph 1, characterized in that the first mixing valve (213), second mixing valve (232) and third mixing valve (244) are 3-way valves, with which either of two paths can be opened individually, or both can be opened simultaneously.
Numbered Paragraph 3. The cooling system (1) according to either of the preceding Numbered Paragraphs, characterized in that the chiller (230) and indirect condenser (241) are incorporated in a refrigerant circuit (50).
Numbered Paragraph 4. The cooling system (1) according to Numbered Paragraph 3, characterized in that the refrigerant circuit (50) can be operated in a hot gas cycle mode and/or vapor injection mode.
Numbered Paragraph 5. The cooling system (1) according to any of the preceding Numbered Paragraphs, characterized in that
   in a first setting S1, the first switching valve (200) connects the first port (201) to the seventh port (207), the eighth port (208) to the second port (202), the sixth port (206) to the third port (203), and the forth port (204) to the fifth port (205),
   in a second setting S2, the first switching valve (200) connects the first port (201) to the seventh port (207), the fourth port (204) to the third port (203), the eighth port (208) to the fifth port (205) and the sixth port (206) to the second port (202),
   in a third setting S3, the first switching valve (200) connects the first port (201) to the fifth port (205), the sixth port (206) to the second port (202), the eighth port (208) to the third port (203), and the fourth port (204) to the seventh port (207),
   in a fourth setting S4, the first switching valve (200) connects the first port (201) to the second port (202), the fourth port (204) to the fifth port (205), the sixth port (206) to the third port (203), and the eighth port (208) to the seventh port (207),
   in a fifth setting S5, the first switching valve (200) connects the first port (201) to the third port (203), the fourth port (204) to the second port (202), the sixth port (206) to the fifth port (205), and the eighth port (208) to the seventh port (207).
Numbered Paragraph 6. The cooling system (1) according to any of the preceding Numbered Paragraphs, characterized in that there is a first temperature sensor (401) at the outlet on the chiller (230), and/or a second temperature sensor (402) between the indirect condenser (241) and the second cab heat exchanger (243), and/or a third temperature sensor (403) downstream of the first electronics circuit water pump (247) and upstream of the first heat-emitting component (240), and/or a fourth temperature sensor (404) downstream of the second port (202) and upstream of the first electronics circuit node (248), and/or a fifth temperature sensor (405) between the fifth port (205) and the first check valve (234).
Numbered Paragraph 7. The cooling system (1) according to any of the preceding Numbered Paragraphs, characterized in that there is a control unit (400) that regulates the valves (200, 213, 244, 232), the refrigerant circuit (50), and the water pumps (233, 247, 235, 245) on the basis of the values from the temperature sensors (401, 402, 403, 405) and a demand for heating or cooling the cab.
Numbered Paragraph 8. A thermal management module (3) that has a cooling system according to Numbered Paragraphs 1 to 7, characterized in that at least the first switching valve (200), refrigerant circuit (50), first chiller circuit water pump (233), second chiller circuit water pump (235), chiller (230), indirect condenser (241), first mixing valve (213), second mixing valve (232), and third mixing valve (244) form the thermal management module (3) as a structural unit.
Numbered Paragraph 9. A motor vehicle (2) that has the thermal management module (3) according to Numbered Paragraph 8, or a cooling system (1) according to Numbered Paragraphs 1 to 7.

### List of Reference Symbols

1 cooling system
2 motor vehicle
3 thermal management module
10 cooler circuit
20 battery circuit
30 chiller circuit
40 electronics circuit
50 refrigerant circuit
111 cooler subcircuit
112 cooler bypass circuit
131 first chiller subcircuit
132 third chiller subcircuit
133 second chiller subcircuit
134 third chiller node
141 first electronics circuit segment
142 second electronics circuit segment
143 third electronics circuit segment
200 first switching valve
201 first port
202 second port
203 third port
204 fourth port
205 fifth port
206 sixth port
207 seventh port
208 eighth port
210 coolant cooler
211 fan
212 slats
213 first mixing valve
220 second heat-emitting component
230 chiller
23 first cab heat exchanger
232 second mixing valve
233 first chiller circuit water pump
234 first check valve
235 second chiller circuit water pump
236 second check valve
237 bypass segment
238 first chiller node
239 second chiller node
240 first heat-emitting component
24 indirect condenser
242 electric coolant heater
243 second cab heat exchanger
244 third mixing valve
245 second electronics circuit water pump
247 first electronics circuit water pump
248 first electronics circuit node
249 third electronics circuit node
250 second electronics circuit note
251 compressor
252 reservoir
253 first expansion valve
254 second expansion valve
255 third expansion valve
256 evaporator
257 refrigerant injection line
258 refrigerant bypass line
259 fourth expansion valve
260 first refrigerant node
261 second refrigerant node
262 third refrigerant node
400 control unit
401-405 first to fifth temperature sensors
L outside air inflow
CA cab air inflow

1-9. (canceled)

10. A cooling system for an electric vehicle comprising a cooler circuit, a battery circuit, a chiller circuit, and an electronics circuit,
further comprising a first switching valve that has a first port, a second port, a third port, a fourth port, a fifth port, a sixth port, a seventh port, and an eighth port, wherein the first switching valve is configured to connect the cooler circuit, battery circuit, chiller circuit, and electronics circuit to one another,
wherein an intake for the cooler circuit is connected to the seventh port and an outlet for the cooler circuit is connected to the eighth port, and
the cooler circuit comprises a first mixing valve with three ports that are configured to subdivide the cooler circuit into a cooler subcircuit and a cooler bypass circuit,
wherein the cooler subcircuit comprises a coolant cooler, wherein an intake for the battery circuit is connected to the fifth port and an outlet for the battery circuit is connected to the sixth port, wherein a second heat-emitting component is in the battery circuit,
wherein an outlet for the chiller circuit is connected to the fourth port and an intake for the chiller circuit is connected to the third port, wherein a first chiller circuit water pump is downstream of the third port and a second mixing valve with three ports is downstream of the first chiller circuit water pump,
wherein a bypass segment connects the second mixing valve to a third chiller node, wherein the third chiller node has a connection to the fourth port, wherein a first chiller subcircuit is formed,
wherein the third chiller node has another port connected to a first check valve, wherein a second chiller subcircuit is formed downstream of the second mixing valve,
further comprising a first chiller node downstream of the second mixing valve in the second chiller subcircuit, which is connected to the intake on a chiller and a return for a third chiller subcircuit, wherein the outlet on the chiller is connected to a second chiller node, which is connected to an intake for the third chiller subcircuit and the first check valve,
further comprising a second chiller circuit water pump downstream of the second chiller node in the third chiller subcircuit, and a first cab heat exchanger is further downstream, and a second check valve is downstream thereof, wherein the second check valve is connected to the first chiller node,
wherein an outlet of the electronics circuit is connected to the first port and an intake of the electronics circuit is connected to the second port, wherein a first electronics node is downstream of the second port, wherein the first electronics node subdivides the electronics circuit into a first electronics circuit segment and second electronics circuit segment, further comprising a first electronics circuit water pump downstream of the first electronics circuit node in the first electronics circuit segment, wherein a first heat-emitting component is downstream of the first electronics circuit water pump,
wherein a third mixing valve with three ports is downstream of the first heat-emitting component, which is connected to the first port, further comprising a second electronics circuit node in the second electronics circuit segment, wherein a second electronics circuit water pump is downstream of the second electronics circuit node, wherein an indirect condenser is downstream of the second electronics circuit water pump, wherein a third electronics circuit node is downstream of the indirect condenser, which is connected to the third mixing valve, wherein a third electronics circuit segment is formed between the third electronics circuit node and the second electronics circuit node, wherein the third electronics circuit segment comprises a second cab heat exchanger.

11. The cooling system according to claim 10, wherein the first mixing valve, the second mixing valve and the third mixing valve are each 3-way valves, wherein either of two paths through the first mixing valve, the second mixing valve, and the third mixing valve are configured to be opened individually, or such that both of the two paths are configured to be opened simultaneously.

12. The cooling system according to claim 10, wherein the chiller and indirect condenser are incorporated in a refrigerant circuit.

13. The cooling system according to claim 12, wherein the refrigerant circuit is configured to be operated in a hot gas cycle mode and/or vapor injection mode.

14. The cooling system according to claim 10, wherein
in a first setting S1, the first switching valve connects the first port to the seventh port, the eighth port to the second port, the sixth port to the third port, and the forth port to the fifth port,
in a second setting S2, the first switching valve connects the first port to the seventh port, the fourth port to the third port, the eighth port to the fifth port and the sixth port to the second port,
in a third setting S3, the first switching valve connects the first port to the fifth port, the sixth port to the second port, the eighth port to the third port, and the fourth port to the seventh port,
in a fourth setting S4, the first switching valve connects the first port to the second port, the fourth port to the fifth port, the sixth port to the third port, and the eighth port to the seventh port, and
in a fifth setting S5, the first switching valve connects the first port to the third port, the fourth port to the second port, the sixth port to the fifth port, and the eighth port to the seventh port.

15. The cooling system according to claim 10, further comprising a first temperature sensor at the outlet on the chiller, and/or a second temperature sensor between the indirect condenser and the second cab heat exchanger, and/or a third temperature sensor downstream of the first electronics circuit water pump and upstream of the first heat-emitting component, and/or a fourth temperature sensor downstream of the second port and upstream of the first electronics circuit node, and/or a fifth temperature sensor between the fifth port and the first check valve.

16. The cooling system according to claim 10, further comprising a control unit that regulates the valves, the refrigerant circuit, and the water pumps on the basis of the values from the temperature sensors and a demand for heating or cooling the cab.

17. A thermal management module comprising a cooling system according to claim 10, wherein at least the first switching valve, the refrigerant circuit, the first chiller circuit water pump, the second chiller circuit water pump, the chiller, the indirect condenser, the first mixing valve, the second mixing valve, and the third mixing valve form the thermal management module as a structural unit.

18. A motor vehicle comprising the thermal management module according to claim 17.

19. A motor vehicle comprising the cooling system according to claim 10.
